(19) United States
(12) Patent Application Publication
(10) Pub. No.: US 2020/0351773 A1
(43) Pub. Date: Nov. 5, 2020

(54) METHOD FOR COMMUNICATING IN WIRELESS LAN SYSTEM AND WIRELESS TERMINAL USING SAME

(71) Applicant: LG ELECTRONICS INC., Seoul (KR)

(72) Inventors: Suhwook KIM, Seoul (KR); Kiseon RYU, Seoul (KR); Jeongki KIM, Seoul (KR); Taewon SONG, Seoul (KR)

(73) Assignee: LG ELECTRONICS INC., Seoul (KR)

(21) Appl. No.: 16/760,024

(22) PCT Filed: Nov. 2, 2018
(86) PCT No.: PCT/KR2018/013251

§ 371 Date: Apr. 28, 2020

Related U.S. Application Data
(60) Provisional application No. 62/580,459, filed on Nov. 2, 2017.

(51) Int. Cl. H04W 52/02; H04L 27/06

(52) U.S. Cl. CPC H04W 52/0216; H04W 84/12; H04L 27/06

(57) ABSTRACT

A method for communicating in a wireless LAN system according to the present embodiment comprises the steps in which: a first wireless terminal transmits an association request frame requesting an association with a second wireless terminal to the second wireless terminal on the basis of a main radio module, wherein the first wireless terminal includes a main radio module for communicating with the second wireless terminal and a WUR module for receiving a wakeup packet modulated by the OOK technique from the second wireless terminal, the association request frame includes operation information for the WUR module, and the operation information includes time information required for the first wireless terminal to transition the main radio module from a doze state to a wake state; and the first wireless terminal receives an association response frame from the second wireless terminal in response to the association request frame.

### BACKGROUND OF THE DISCLOSURE

### Field of the Disclosure

The present disclosure relates to wireless communication, and more particularly, to a method for communicating in a wireless LAN system and a wireless terminal using the same.

### Related Art

Discussion for a next-generation wireless local area network (WLAN) is in progress. In the next-generation WLAN, an object is to 1) improve an institute of electronic and electronics engineers (IEEE) 802.11 physical (PHY) layer and a medium access control (MAC) layer in bands of 2.4 GHz and 5 GHz, 2) increase spectrum efficiency and area throughput, 3) improve performance in actual indoor and outdoor environments such as an environment in which an interference source exists, a dense heterogeneous network environment, and an environment in which a high user load exists, and the like.

An environment which is primarily considered in the next-generation WLAN is a dense environment in which access points (APs) and stations (STAs) are a lot and under the dense environment, improvement of the spectrum efficiency and the area throughput is discussed. Further, in the next-generation WLAN, in addition to the indoor environment, in the outdoor environment which is not considerably considered in the existing WLAN, substantial performance improvement is concerned.

In detail, scenarios such as wireless office, smart home, stadium, Hotspot, and building/apartment are largely concerned in the next-generation WLAN and discussion about improvement of system performance in a dense environment in which the APs and the STAs are a lot is performed based on the corresponding scenarios.

### SUMMARY OF THE DISCLOSURE

The present disclosure provides a method for communicating in a wireless LAN system having an improved performance in terms of power efficiency and a wireless terminal using the same based on information on a WUR capability exchanged during an association procedure between each wireless terminal.

In an aspect, a method for communicating in a wireless local area network (LAN) system, wherein a first wireless terminal transmits an association request frame to request association with a second wireless terminal to the second wireless terminal based on a main radio module, the first wireless terminal includes a main radio module configured to communicate with the second wireless terminal and a wake-up radio (WUR) module configured to receive a wake-up packet modulated by an on-off keying (OOK) scheme from the second wireless terminal, and the association request frame includes operation information for the WUR module, wherein the method including: including, by the operation information, time information required for the first wireless terminal to change the main radio module from a doze state to an awake state; and receiving, by the first wireless terminal, an association response frame from the second wireless terminal in response to the association request frame.

According to an embodiment of the present disclosure, there are provided a method for communicating in a wireless LAN system having an improved performance in terms of power efficiency and a wireless terminal using the same based on information on a WUR capability exchanged during an association procedure between each wireless terminal.

### BRIEF DESCRIPTION OF THE DRAWINGS

FIG. 1 is a conceptual view illustrating the structure of a wireless local area network (WLAN).

FIG. 2 is a diagram illustrating an example of a physical protocol data unit (PPDU) used in an electrical and electronics engineers (IEEE) standard.

FIG. 3 is a conceptual view illustrating an authentication and association procedure after scanning of an access point (AP) and a station (STA).

FIG. 4 is an internal block diagram of a wireless terminal receiving a wake-up packet.

FIG. 5 is a conceptual diagram illustrating a method in which a wireless terminal receives a wake-up packet and a data packet.

FIG. 6 illustrates an example of a format of a wake-up packet.

FIG. 7 illustrates a signal waveform of a wake-up packet.

FIG. 8 illustrates a wake-up radio (WUR) PPDU based on frequency division multiplexing access (FDMA) having a 40 MHz channel bandwidth.

FIG. 9 is a diagram illustrating a design process of a pulse according to an OOK scheme.

FIG. 10 illustrates a basic operation for a WUR STA.

FIG. 11 is a diagram illustrating a signaling procedure for a WUR module according to the present embodiment.

FIG. 12 is a diagram illustrating a method for communicating in a wireless LAN system according to the present embodiment.

FIG. 13 is a block view illustrating a wireless device to which the exemplary embodiment of the present specification can be applied.

### DESCRIPTION OF EXEMPLARY EMBODIMENTS

The above-described features and the following detailed description are exemplary contents for helping a description and understanding of the present specification. That is, the present specification is not limited to this embodiment and may be embodied in other forms. The following embodiments are merely examples to fully disclose the present specification, and are descriptions to transfer the present specification to those skilled in the art. Therefore, when there are several methods for implementing components of the present specification, it is necessary to clarify that the present specification may be implemented with a specific one of these methods or equivalent thereof.

In the present specification, when there is a description in which a configuration includes specific elements, or when there is a description in which a process includes specific steps, it means that other elements or other steps may be further included. That is, the terms used in the present specification are only for describing specific embodiments and are not intended to limit the concept of the present specification. Furthermore, the examples described to aid the understanding of the present specification also include complementary embodiments thereof.

The terms used in the present specification have the meaning commonly understood by one of ordinary skill in the art to which the present specification belongs. Terms commonly used should be interpreted in a consistent sense in the context of the present specification. Further, terms used in the present specification should not be interpreted in an idealistic or formal sense unless the meaning is clearly defined. Hereinafter, embodiments of the present specification will be described with reference to the accompanying drawings.

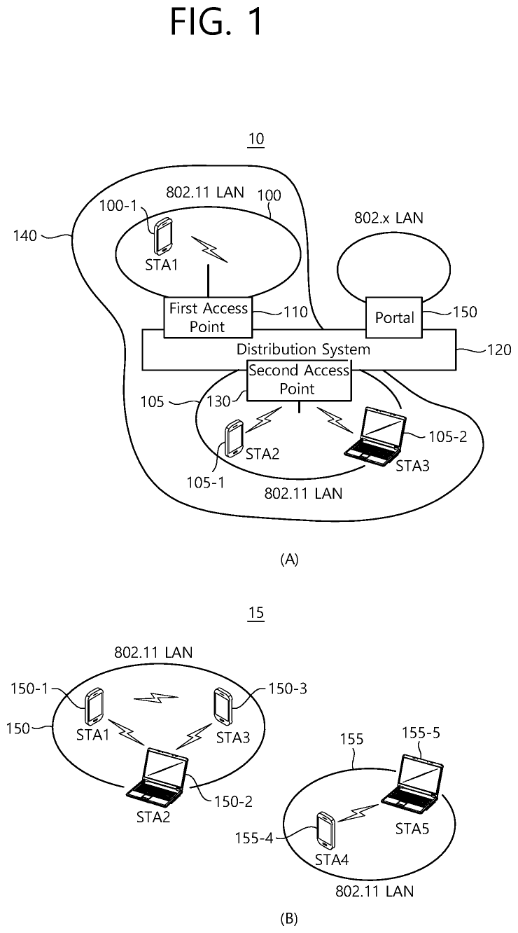

FIG. 1 is a conceptual diagram illustrating a structure of a WLAN system. FIG. 1(A) illustrates a structure of an infrastructure network of institute of electrical and electronic engineers (IEEE) 802.11.

Referring to FIG. 1(A), a WLAN system 10 of FIG. 1(A) may include at least one basic service set (hereinafter, referred to as ‘BSS’) 100 and 105. The BSS is a set of access points (hereinafter, APs) and stations (hereinafter, STAs) that can successfully synchronize and communicate with each other and is not a concept indicating a specific area.

For example, a first BSS 100 may include a first AP 110 and one first STA 100-1. A second BSS 105 may include a second AP 130 and one or more STAs 105-1 and 105-2.

The infrastructure BSSs 100 and 105 may include at least one STA, APs 110 and 130 for providing a distribution service, and a distribution system (DS) 120 for connecting a plurality of APs.

The DS 120 may connect a plurality of BSSs 100 and 105 to implement an extended service set (hereinafter, ‘ESS’) 140. The ESS 140 may be used as a term indicating one network to which at least one AP 110 and 130 is connected through the DS 120. At least one AP included in one ESS 140 may have the same service set identification (hereinafter, SSID).

A portal 150 may serve as a bridge for connecting a WLAN network (IEEE 802.11) with another network (e.g., 802.X).

In a WLAN having a structure as illustrated in FIG. 1(A), a network between the APs 110 and 130 and a network between APs 110 and 130 and STAs 100-1, 105-1, and 105-2 may be implemented.

FIG. 1(B) is a conceptual diagram illustrating an independent BSS. Referring to FIG. 1(B), a WLAN system 15 of FIG. 1(B) may perform communication by setting a network between STAs without the APs 110 and 130, unlike FIG. 1(A). A network that performs communication by setting a network even between STAs without the APs 110 and 130 is defined to an ad-hoc network or an independent basic service set (hereinafter, ‘BSS’).

Referring to FIG. 1(B), an IBSS 15 is a BSS operating in an ad-hoc mode. Because the IBSS does not include an AP, there is no centralized management entity. Therefore, in the IBSS 15, STAs 150-1, 150-2, 150-3, 155-4, and 155-5 are managed in a distributed manner.

All STAs 150-1, 150-2, 150-3, 155-4, and 155-5 of the IBSS may be configured with mobile STAs, and access to a distributed system is not allowed. All STAs of the IBSS form a self-contained network.

The STA described in the present specification is a random function medium including a medium access control (hereinafter, MAC) following a standard of the Institute of Electrical and Electronics Engineers (IEEE) 802.11 standard and a physical layer interface for a wireless medium and may broadly be used as a meaning including both an AP and a non-AP station (STA).

The STA described in the present specification may also be referred to as various names such as a mobile terminal, a wireless device, a wireless transmit/receive unit (WTRU), a user equipment (UE), a mobile station (MS), a mobile subscriber unit, or simply a user.

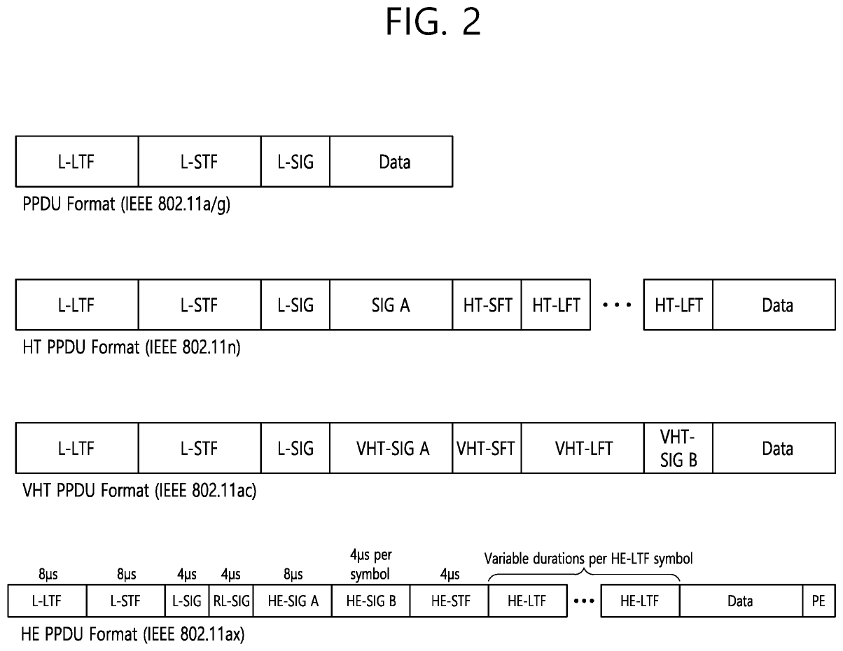

FIG. 2 is a diagram illustrating an example of a PPDU used in an IEEE standard.

As illustrated in FIG. 2, various types of PHY protocol data units (PPDUs) may be used in a standard such as IEEE a/g/n/ac, etc. In detail, LTF and STF fields include a training signal, SIG-A and SIG-B include control information for a receiving station, and a data field includes user data corresponding to a PSDU.

The present embodiment proposes an improved scheme for a signal (or control information field) used for a data field of a PPDU. The signal mentioned in the present embodiment may be applied onto high efficiency PPDU (HE PPDU) according to an IEEE 802.11ax standard. The signal mentioned in the present specification may be HE-SIG-A and/or HE-SIG-B included in the HE PPDU. For example, the HE-SIG-A and the HE-SIG-B may also be respectively represented as SIG-A and SIG-B. However, the signal mentioned in the present specification is not necessarily limited to an HE-SIG-A and/or HE-SIG-B standard and may be applied to control/data fields having various names, which include control information in a wireless communication system transferring user data.

In addition, the HE PPDU of FIG. 2 is an example of a PPDU for multiple users. The HE-SIG-B may be included only when the PPDU is for multiple users. The HE SIG-B may be omitted in a PPDU for a single user.

As illustrated, the HE-PPDU for multiple users (MUs) may include various fields such as legacy-short training field (L-STF), legacy-long training field (L-LTF), legacy-signal (L-SIG), high efficiency-signal A (HE-SIG A), high efficiency-signal-B (HE-SIG B), high efficiency-short training field (HE-STF), high efficiency-long training field (HE-LTF), data field (alternatively, a MAC payload), and packet extension (PE). Each of the fields may be transmitted during an illustrated time period (that is, 4 or 8 μs).

The PPDU used in the IEEE standard is mainly described as a PPDU structure transmitted with a channel bandwidth of 20 MHz. The PPDU structure transmitted with a bandwidth (e.g., 40 MHz and 80 MHz) wider than the channel bandwidth of 20 MHz may be a structure in which linear scaling is applied to the PPDU structure used in the channel bandwidth of 20 MHz.

The PPDU structure used in the IEEE standard may be generated based on 64 Fast Fourier Transforms (FTFs), and a cyclic prefix portion (CP portion) may be ¼. In this case, a length of an effective symbol interval (or FFT interval) may be 3.2 us, a CP length may be 0.8 us, and symbol duration may be 4 us (3.2 us+0.8 us) that adds the effective symbol interval and the CP length.

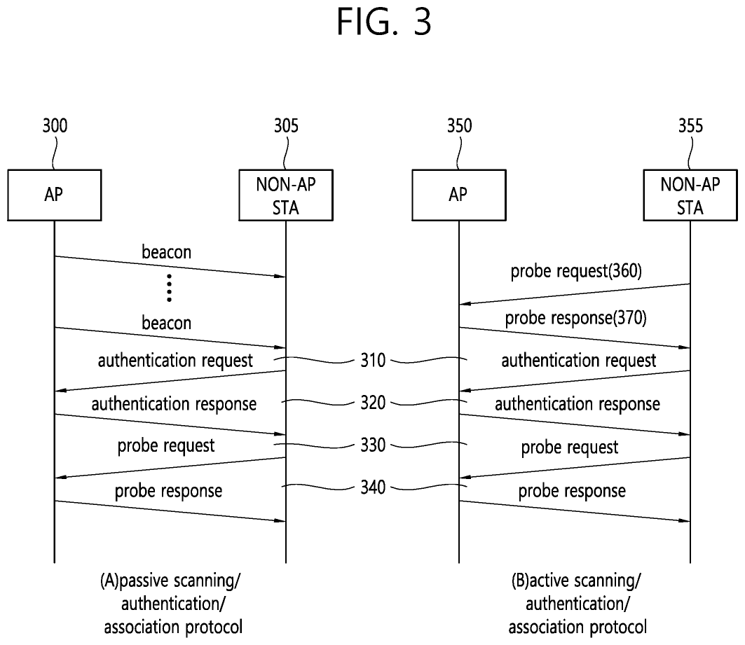

FIG. 3 is a conceptual view illustrating an authentication and association procedure after scanning of an AP and an STA.

Referring to FIG. 3, a non-AP STA may perform the authentication and association procedure with respect to one AP among a plurality of APs which have completed a scanning procedure through passive/active scanning. For example, the authentication and association procedure may be performed through 2-way handshaking.

FIG. 3(A) is a conceptual view illustrating an authentication and association procedure after passive scanning, and FIG. 3(B) is a conceptual view illustrating an authentication and association procedure after active scanning.

The authentication and association procedure may be performed regardless of whether the active scanning or the passive scanning is used. For example, APs 300 and 350 exchange an authentication request frame 310, an authentication response frame 320, an association request frame 330, and an association response frame 340 with the non-AP STAs 305 and 355 to perform the authentication and association procedure.

More specifically, the authentication procedure may be performed by transmitting the authentication request frame 310 from the non-AP STAs 305 and 355 to the APs 300 and 350. The APs 300 and 350 may transmit the authentication response frame 320 to the non-AP STAs 305 and 355 in response to the authentication request frame 310. An authentication frame format is disclosed in IEEE 802.11 8.3.3.11.

More specifically, the association procedure may be performed when the non-AP STAs 305 and 355 transmit the association request frame 330 to the APs 300 and 305. The APs 300 and 350 may transmit the association response frame 340 to the non-AP STAs 305 and 355 in response to the association request frame 330.

The association request frame 330 may include information on capability of the non-AP STAs 305 and 355. The APs 300 and 350 may determine whether the non-AP STAs 305 and 355 can be supported based on the information on capability of the non-AP STAs 305 and 355 and included in the association request frame 330.

For example, if the support is available, the AP 300 and 350 may transmit to the non-AP STAs 305 and 355 by allowing the association response frame 340 to contain whether the association request frame 330 is acceptable, its reason, and its supportable capability information. An association frame format is disclosed in IEEE 802.11 8.3.3.5/8.3.3.6.

When up to the association procedure mentioned in FIG. 3 is performed, normal data transmission and reception procedures may be performed between the AP and the STA.

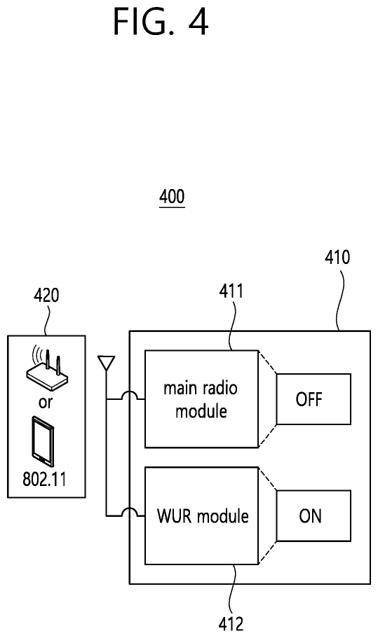

FIG. 4 is an internal block diagram of a wireless terminal receiving a wake-up packet.

Referring to FIG. 4, a WLAN system 400 according to the present embodiment may include a first wireless terminal 410 and a second wireless terminal 420.

The first wireless terminal 410 may include a main radio module 411 related to main radio (e.g., 802.11 radio) and a WUR module 412 including low-power wake-up radio (LP WUR). In the present specification, the main radio module may be referred to as a primary component radio (hereinafter, PCR) module.

For example, the main radio module 411 may include a plurality of circuits supporting Wi-Fi, Bluetooth®radio (hereinafter, BT radio), and Bluetooth®Low Energy radio (hereinafter, BLE radio).

In the present specification, the first wireless terminal 410 may control the main radio module 411 in an awake state or a doze state.

For example, when the main radio module 411 is in the awake state, the first wireless terminal 410 is able to transmit an 802.11-based frame (e.g., 802.11-type PPDU) or receive an 802.11-based frame based on the main radio module 411. For example, the 802.11-based frame may be a non-HT PPDU of a 20 MHz band.

For another example, when the main radio module 411 is in the doze state, the first wireless terminal 410 is not able to transmit the 802.11-based frame (e.g., 802.11-type PPDU) or receive the 802.11-based frame based on the main radio module 411.

That is, when the main radio module 411 is in the doze state (e.g., OFF state), the first wireless terminal 400 is not able to receive a frame (e.g., 802.11-type PPDU) transmitted by the second wireless terminal 420 (e.g., AP) until the WUR module 412 wakes up the main radio module 411 to transition to the awake state according to a wake-up packet (hereinafter, WUP).

In the present specification, the first wireless terminal 410 may control the WUR module 412 in the turn-off state or the turn-on state.

For example, the first wireless terminal 410 including the WUR module 412 in the turn-on state is able to receive (or demodulate) only a specific-type frame (i.e., WUR PPDU) transmitted by the second wireless terminal 420 (e.g., AP).

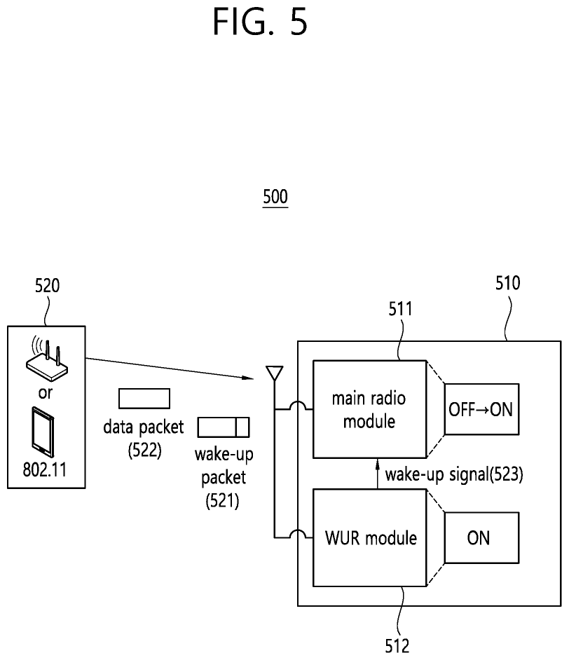

In this case, the specific-type frame (e.g., WUR PPDU) may be a frame (e.g., wake-up packet) modulated by an on-off keying (OOK) modulation scheme described below with reference to FIG. 5.

For example, the first wireless terminal 410 including the WUR module 412 in the turn-off state is not able to receive (or demodulate) a specific-type frame (e.g., WUR PPDU) transmitted by the second wireless terminal 420 (e.g., AP).

In the present specification, the first wireless terminal 410 may separately operate the main radio module (e.g., PCR module) 411 and the WUR module 412.

Hereinafter, for concise and clear understanding of the present disclosure, when the main radio module 411 is in an awake state and the WUR module 412 is in a turn-off state, it may be described that the first wireless terminal 410 operates in a WLAN mode.

Further, when the WUR module 412 is in a turn-on state, it may be described that the first wireless terminal 410 operates in the WUR mode.

Specifically, the first wireless terminal 410 in the WUR mode may receive a wakeup packet (WUP) based on the WUR module 412 in a turn-on state. In addition, when the WUP is received in the WUR module 412, the first wireless terminal 410 in the WUR mode may control the WUR module 412 to wake the main radio module 411.

Further, when the main radio module 411 is in a doze state and the WUR module 412 is in a turn-on state, it may be described that the first wireless terminal 410 operates in a WUR-PS mode.

In the present specification, in order to represent an ON state of a specific module included in the wireless terminal, the term regarding the awake state and the turn-on state may be used interchangeably. In the same context, in order to represent an OFF state of the specific module included in the wireless terminal, the term regarding the doze state and the turn-off state may be used interchangeably.

The first wireless terminal 410 according to the present embodiment may receive a legacy frame (e.g., 802.11-based PPDU) from the different wireless terminal 420 (e.g., AP) based on the main radio module 411 or WUR module 412 in the awake state.

The WUR module 412 in the doze state may be a receiver for transitioning the main radio module 411 to the awake state. That is, the WUR module 412 may not include a transmitter.

The first wireless terminal 410 may operate the WUR module 412 in the turn-on state while the main radio module 411 is in the doze state.

For example, when the wake-up packet is received based on the WUR module 412 in the turn-on state, the first wireless terminal 410 may control the main radio module 411 in the doze state to transition to the awake state.

For reference, the LP WUR included in the WUR module 412 aims to consume target power less than 1 mW in the active state. In addition, the LP WUR may use a narrow bandwidth less than 5 MHz.

In addition, power consumed by the LP WUR may be less than 1 mW. In addition, a target transmission range of the LP WUR may be implemented to be the same as the conventional 802.11 target transmission range.

The second wireless terminal 420 according to the present embodiment may transmit user data based on main radio (i.e., 802.11). The second wireless terminal 420 may transmit a wake-up packet (WUP) for the WUR module 412.

FIG. 5 is a conceptual diagram illustrating a method in which a wireless terminal receives a wake-up packet and a data packet.

Referring to FIG. 4 and FIG. 5, a WLAN system 500 according to the present embodiment may include a first wireless terminal 510 corresponding to a receiving terminal and a second wireless terminal 520 corresponding to a transmitting terminal.

A basic operation of the first wireless terminal 510 of FIG. 5 may be understood through a description of the first wireless terminal 410 of FIG. 4. Similarly, a basic operation of the second wireless terminal 520 of FIG. 5 may be understood through a description of the second wireless terminal 420 of FIG. 4.

Referring to FIG. 5, the wake-up packet 521 may be received in a WUR module 512 in a turn-on state (e.g., ON state).

In this case, the WUR module 512 may transfer a wake-up signal 523 to a main radio module 511 in a doze state (e.g., OFF state) in order to accurately receive a data packet 522 to be received after the wake-up packet 521.

For example, the wake-up signal 523 may be implemented based on an internal primitive of the first wireless terminal 510.

For example, when the wake-up signal 523 is received in the main radio module 511 in the doze state (e.g., OFF state), the first wireless terminal 510 may control the main radio module 511 to transition to the awake state (i.e., ON state).

For example, when the main radio module 511 transitions from the doze state (e.g., OFF state) to the awake state (i.e., ON state), the first wireless terminal 510 may activate all or some of a plurality of circuits (not shown) supporting Wi-Fi, BT radio, and BLE radio included in the main radio module 511.

For another example, actual data included the wake-up packet 521 may be directly transferred to a memory block (not shown) of a receiving terminal even if the main radio module 511 is in the doze state (e.g., OFF state).

For another example, when an IEEE 802.11 MAC frame is included in the wake-up packet 521, the receiving terminal may activate only a MAC processor of the main radio module 511. That is, the receiving terminal may maintain a PHY module of the main radio module 511 to be in an inactive state. The wake-up packet 521 of FIG. 5 will be described below in greater detail with reference to the accompanying drawings.

The second wireless terminal 520 may be configured to transmit the wake-up packet 521 to the first wireless terminal 510.

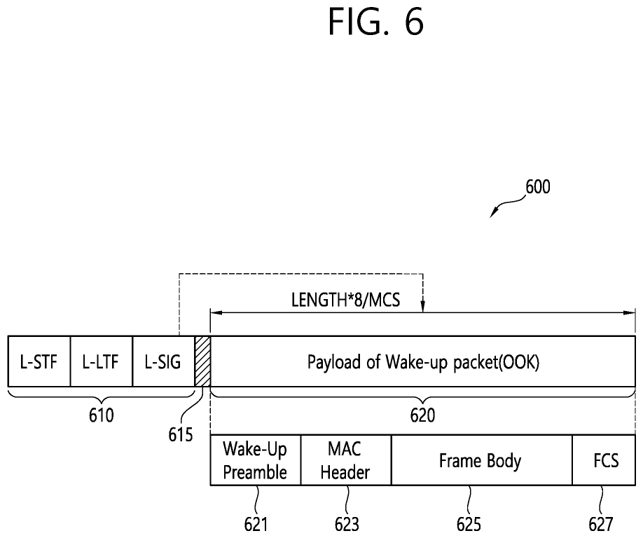

FIG. 6 illustrates an example of a WUR PPDU format.

Referring to FIGS. 1 to 6, a wakeup packet 600 may include at least one legacy preamble 610. In addition, the wake-up packet 600 may include a payload 620 after the legacy preamble 610. The payload 620 may be modulated by a simple modulation scheme (e.g., On-Off Keying (OOK) modulation scheme). The wakeup packet 600 including a payload may be transmitted based on a relatively small bandwidth.

Referring to FIGS. 1 to 6, the second wireless terminal (e.g., 520) may be configured to generate and/or transmit wakeup packets 521 and 600. The first wireless terminal (e.g., 510) may be configured to process the received wakeup packet 521.

For example, the wake-up packet 600 may include any other preamble (not shown) or a legacy preamble 610 defined in the existing IEEE 802.11 standard. The wakeup packet 600 may include one packet symbol 615 after the legacy preamble 610. Further, the wake-up packet 600 may include a payload 620.

The legacy preamble 610 may be provided for coexistence with a legacy STA. An L-SIG field for protecting a packet may be used in the legacy preamble 610 for the coexistence.

For example, an 802.11 STA may detect a start portion of a packet through the L-STF field in the legacy preamble 610. The STA may detect an end portion of the 802.11 packet through the L-SIG field in the legacy preamble 610.

In order to reduce false alarm of the 802.11n terminal, one modulated symbol 615 may be added after the L-SIG of FIG. 6. One symbol 615 may be modulated according to a BPSK (BiPhase Shift Keying) scheme. One symbol 615 may have a length of 4 us. One symbol 615 may have a 20 MHz bandwidth as a legacy part.

The legacy preamble 610 may be understood as a field for a third party legacy STA (STA not including LP-WUR). In other words, the legacy preamble 610 may not be decoded by the LP-WUR.

The payload 620 may include a wake-up preamble field 621, a MAC header field 623, a frame body field 625, and a frame check sequence (FCS) field 627.

The wake-up preamble field 621 may include a sequence for identifying the wake-up packet 600. For example, the wake-up preamble field 621 may include a pseudo random noise sequence (PN sequence).

The MAC header field 624 may include address information (or an identifier of a receiving device) indicating a receiving terminal for receiving the wake-up packet 600. The frame body field 626 may include other information of the wakeup packet 600.

The frame body 626 may include length information or size information of the payload. Referring to FIG. 6, length information of a payload may be calculated based on length information and MCS information included in the legacy preamble 610.

The FCS field 628 may include a cyclic redundancy check (CRC) value for error correction. For example, the FCS field 628 may include a CRC-8 value or a CRC-16 value for the MAC header field 623 and the frame body 625.

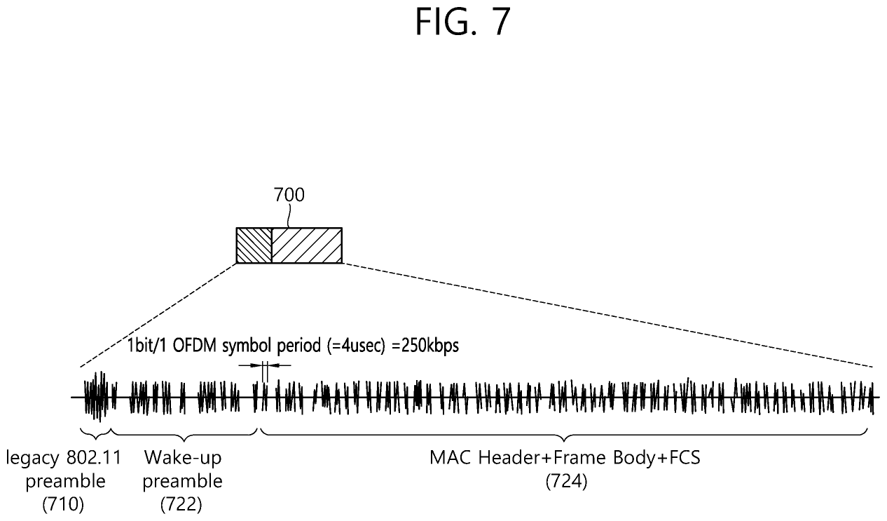

FIG. 7 illustrates a signal waveform of a wake-up packet.

Referring to FIG. 7, a wake-up packet 700 may include a legacy preamble (802.11 preamble) 710 and payloads 722 and 724 modulated based on an on-off keying (OOK) scheme. That is, the wake-up packet WUP according to the present embodiment may be understood in a form in which a legacy preamble and a new LP-WUR signal waveform coexist.

An OOK scheme may not be applied to the legacy preamble 710 of FIG. 7. As described above, the payloads 722 and 724 may be modulated according to the OOK scheme. However, the wake-up preamble 722 included in the payloads 722 and 724 may be modulated according to another modulation scheme.

For example, it may be assumed that the legacy preamble 710 is transmitted based on a channel band of 20 MHz to which 64 FFTs are applied. In this case, the payloads 722 and 724 may be transmitted based on a channel band of about 4.06 MHz.

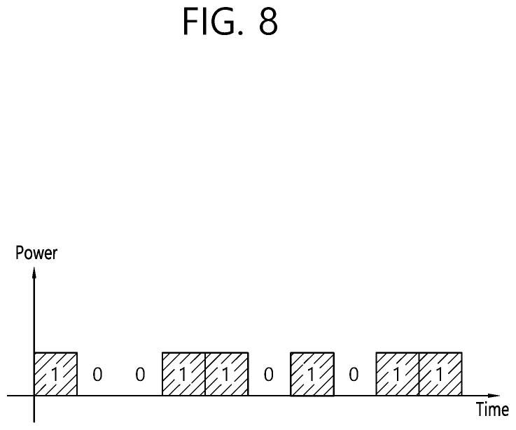

FIG. 8 is a diagram illustrating a procedure in which power consumption is determined according to a ratio of bit values constituting binary sequence information.

Referring to FIG. 8, binary sequence information having ‘1’ or ‘0’ as a bit value may be expressed. Communication according to the OOK modulation scheme may be performed based on a bit value of the binary sequence information.

For example, when a light emitting diode is used for visible light communication, if the bit value constituting binary sequence information is ‘1’, the light emitting diode may be turned on, and if the bit value is ‘0’, the light emitting diode may be turned off.

As the receiving device receives and restores data transmitted in the form of visible light according to flickering of the light emitting diode, communication using visible light is enabled. However, because the human eye cannot recognize flickering of the light emitting diode, the person feels that the lighting is continuously maintained.

For convenience of description, as shown in FIG. 8, binary sequence information having 10 bit values may be provided. For example, binary sequence information having a value of ‘1001101011’ may be provided.

As described above, when the bit value is ‘1’, the transmitting terminal is turned on, and when the bit value is ‘0’, the transmitting terminal is turned off, and thus symbols corresponding to 6 bit values of the above 10 bit values are turned on.

Because the wake-up receiver WUR according to the present embodiment is included in the receiving terminal, transmission power of the transmitting terminal may not be largely considered. The reason why the OOK scheme is used in this embodiment is that power consumed in a decoding process of the received signal is very small.

Until the decoding procedure is performed, there may be no significant difference between power consumed by the main radio and power consumed by the WUR. However, as a decoding procedure is performed by the receiving terminal, a large difference may occur between power consumed in the main radio module and power consumed in the WUR module. Below is approximate power consumption.
Existing Wi-Fi power consumption is about 100 mW. Specifically, power consumption of Resonator+Oscillator+PLL (1500 uW)->LPF (300 uW)->ADC (63 uW)->decoding processing (Orthogonal frequency-division multiplexing (OFDM) receiver) (100 mW) may occur.
However, WUR power consumption is about 1 mW. Specifically, power consumption of Resonator+Oscillator (600 uW)->LPF (300 uW)->ADC (20 uW)->decoding processing (Envelope detector) (1 uW) may occur.

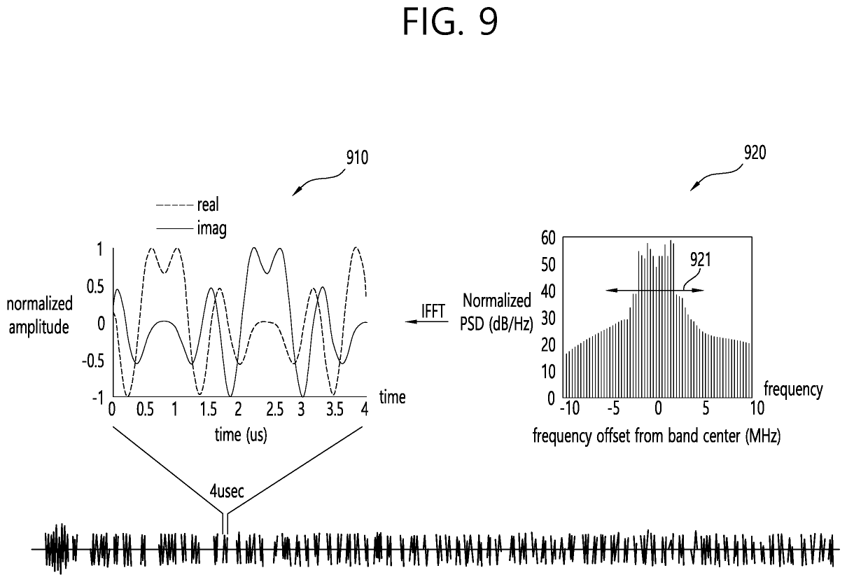

FIG. 9 is a diagram illustrating a design process of a pulse according to an OOK scheme.

A wireless terminal according to the present embodiment may use an existing orthogonal frequency-division multiplexing (OFDM) transmitter of 802.11 in order to generate pulses according to an OOK scheme. The existing 802.11 OFDM transmitter may generate a 64-bit sequence by applying 64-point IFFT.

Referring to FIG. 1 to FIG. 9, the wireless terminal according to the present embodiment may transmit a payload of a modulated wake-up packet (WUP) according to an OOK scheme. The payload (e.g., 620 of FIG. 6) according to the present embodiment may be implemented based on an ON-signal and an OFF-signal.

The OOK scheme may be applied for the ON-signal included in the payload (e.g., 620 of FIG. 6) of the WUP. In this case, the ON-signal may be a signal having an actual power value.

With reference to a frequency domain graph 920, an ON-signal included in the payload (e.g., 620 of FIG. 6) may be obtained by performing IFFT for the N2 number of subcarriers (N2 is a natural number) among the N1 number of subcarriers (N1 is a natural number) corresponding to a channel band of the WUP. Further, a predetermined sequence may be applied to the N2 number of subcarriers.

For example, a channel band of the wakeup packet WUP may be 20 MHz. The N1 number of subcarriers may be 64 subcarriers, and the N2 number of subcarriers may be 13 consecutive subcarriers (921 in FIG. 9). A subcarrier interval applied to the wakeup packet WUP may be 312.5 kHz.

The OOK scheme may be applied for an OFF-signal included in the payload (e.g., 620 of FIG. 6) of the WUP. The OFF-signal may be a signal that does not have an actual power value. That is, the OFF-signal may not be considered in a configuration of the WUP.

The ON-signal included in the payload (620 of FIG. 6) of the WUP may be determined (i.e., demodulated) to a 1-bit ON-signal (i.e., ‘1’) by the WUR module (e.g., 512 of FIG. 5). Similarly, the OFF-signal included in the payload may be determined (i.e., demodulated) to a 1-bit OFF-signal (i.e., ‘0’) by the WUR module (e.g., 512 of FIG. 5).

A specific sequence may be preset for a subcarrier set 921 of FIG. 9. In this case, the preset sequence may be a 13-bit sequence. For example, a coefficient corresponding to the DC subcarrier in the 13-bit sequence may be ‘0’, and the remaining coefficients may be set to ‘1’ or ‘−1’.

With reference to the frequency domain graph 920, the subcarrier set 921 may correspond to a subcarrier whose subcarrier indices are ‘−6’ to ‘+6’.

For example, a coefficient corresponding to a subcarrier whose subcarrier indices are ‘−6’ to ‘−1’ in the 13-bit sequence may be set to ‘1’ or ‘-1’. A coefficient corresponding to a subcarrier whose subcarrier indices are ‘1’ to ‘6’ in the 13-bit sequence may be set to ‘1’ or ‘−1’.

For example, a subcarrier whose subcarrier index is ‘0’ in the 13-bit sequence may be nulled. All coefficients of the remaining subcarriers (subcarrier indexes ‘−32’ to ‘−7’ and subcarrier indexes ‘+7’ to ‘+31’), except for the subcarrier set 921 may be set to ‘0’.

The subcarrier set 921 corresponding to consecutive 13 subcarriers may be set to have a channel bandwidth of about 4.06 MHz. That is, power by signals may be concentrated at 4.06 MHz in the 20 MHz band for the wake-up packet (WUP).

According to the present embodiment, when a pulse according to the OOK scheme is used, power is concentrated in a specific band and thus there is an advantage that a signal to noise ratio (SNR) may increase, and in an AC/DC converter of the receiver, there is an advantage that power consumption for conversion may be reduced. Because a sampling frequency band is reduced to 4.06 MHz, power consumption by the wireless terminal may be reduced.

An OFDM transmitter of 802.11 according to the present embodiment may have may perform IFFT (e.g., 64-point IFFT) for the N2 number (e.g., consecutive 13) of subcarriers of the N1 number (e.g., 64) of subcarriers corresponding to a channel band (e.g., 20 MHz band) of a wake-up packet.

In this case, a predetermined sequence may be applied to the N2 number of subcarriers. Accordingly, one ON-signal may be generated in a time domain. One bit information corresponding to one ON-signal may be transferred through one symbol.

For example, when a 64-point IFFT is performed, a symbol having a length of 3.2 us corresponding to a subcarrier set 921 may be generated. Further, when a cyclic prefix (CP, 0.8 us) is added to a symbol having a length of 3.2 us corresponding to the subcarrier set 921, one symbol having a total length of 4 us may be generated, as in the time domain graph 910 of FIG. 9.

Further, the OFDM transmitter of 802.11 may not transmit an OFF-signal.

According to the present embodiment, a first wireless terminal (e.g., 510 of FIG. 5) including a WUR module (e.g., 512 of FIG. 5) may demodulate a receiving packet based on an envelope detector that extracts an envelope of a received signal.

For example, the WUR module (e.g., 512 of FIG. 5) according to the present embodiment may compare a power level of a received signal obtained through an envelope of the received signal with a predetermined threshold level.

If a power level of the received signal is higher than a threshold level, the WUR module (e.g., 512 of FIG. 5) may determine the received signal to a 1-bit ON-signal (i.e., ‘1’). If a power level of the received signal is lower than a threshold level, the WUR module (e.g., 512 of FIG. 5) may determine the received signal to a 1-bit OFF-signal (i.e., ‘0’).

Generalizing contents of FIG. 9, each signal having a length of K (e.g., K is a natural number) in the 20 MHz band may be transmitted based on consecutive K subcarriers of 64 subcarriers for the 20 MHz band. For example, K may correspond to the number of subcarriers used for transmitting a signal. Further, K may correspond to a bandwidth of a pulse according to the OOK scheme.

All coefficients of the remaining subcarriers, except for K subcarriers among 64 subcarriers may be set to ‘0’.

Specifically, for a one bit OFF-signal corresponding to ‘0’ (hereinafter, information 0) and a one bit ON-signal corresponding to ‘1’ (hereinafter, information 1), the same K subcarriers may be used. For example, the used index for the K subcarriers may be expressed as 33-floor (K/2): 33+ceil (K/2)−1.

In this case, the information 1 and the information 0 may have the following values.
Information 0=zeros (1, K)
Information 1=alpha*ones (1, K)

The alpha is a power normalization factor and may be, for example, 1/sqrt (K).

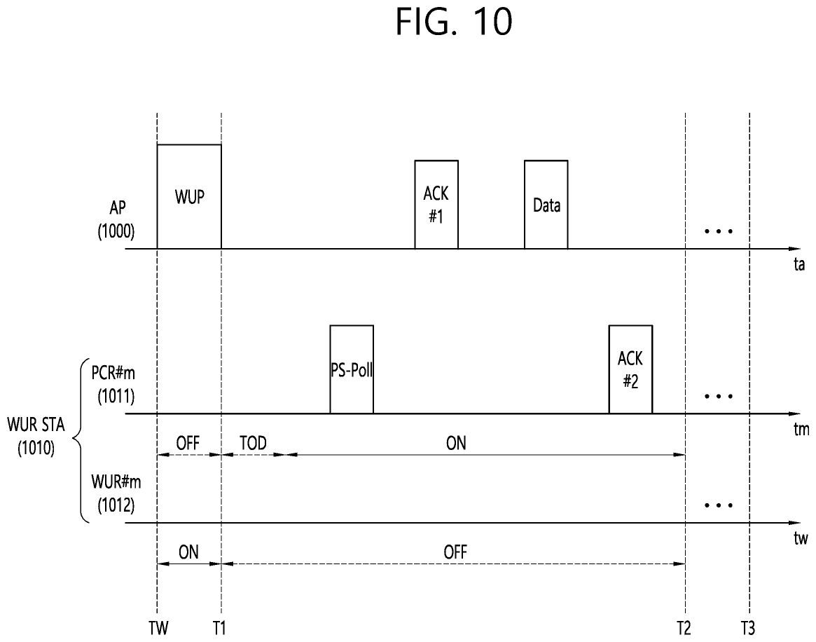

FIG. 10 illustrates a basic operation for a WUR STA.

Referring to FIG. 10, an AP 1000 may correspond to the second wireless terminal 520 of FIG. 5. A horizontal axis of the AP 1000 of FIG. 10 may indicate a time ta. A vertical axis of the AP 1000 of FIG. 10 may be related to presence of a packet (or frame) to be transmitted by the AP 1000.

A WUR STA 1010 may correspond to the first wireless terminal 510 of FIG. 5. The WUR STA 1010 may include a main radio module (or PCR # m) 1011 and a WUR module (or WUR # m) 1012. The main radio module 1011 of FIG. 10 may correspond to the main radio module 511 of FIG. 5.

Specifically, the main radio module 1011 may support both a reception operation for receiving an 802.11-based packet from the AP 1000 and a transmission operation for transmitting the 802.11-based packet to the AP 1000. For example, the 802.11-based packet may be a packet modulated according to an OFDM scheme.

A horizontal axis of the main radio module 1011 may indicate a time tm. An arrow displayed at the lower end of the horizontal axis of the main radio module 1011 may be related to a power state (e.g., ON state or OFF state) of the main radio module 1011. The vertical axis of the main radio module 1011 may be related to presence of a packet to be transmitted based on the main radio module 1011.

The WUR module 1012 of FIG. 10 may correspond to the WUR module 512 of FIG. 5. Specifically, the WUR module 1012 may support only a reception operation for a packet modulated from the AP 1000 according to an on-off keying (OOK) scheme.

A horizontal axis of the WUR module 1012 may indicate a time tw. Further, an arrow disposed at the lower end of the horizontal axis of the WUR module 1012 may be related to a power state (e.g., ON state or OFF state) of the WUR module 1012.

The WUR STA 1010 of FIG. 10 may be understood as a wireless terminal associated with the AP 1000 by performing an association procedure.

Referring to FIG. 5 and FIG. 10, the AP 1000 of FIG. 10 may correspond to the second wireless terminal 520 of FIG. 5. A horizontal axis of the AP 1000 of FIG. 10 may represent a time ta. A vertical axis of the AP 1000 of FIG. 10 may be related to presence of a packet (or frame) to be transmitted by the AP 1000.

The WUR STA 1010 may correspond to the first wireless terminal 510 of FIG. 5. The WUR STA 1010 may include a main radio module (or PCR # m) 1011 and a WUR module (or WUR # m) 1012. The main radio module 1011 of FIG. 10 may correspond to the main radio module 511 of FIG. 5.

Specifically, the main radio module 1011 may support both a reception operation for receiving an 802.11-based packet from the AP 1000 and a transmission operation for transmitting an 802.11-based packet to the AP 1000. For example, the 802.11-based packet may be a packet modulated according to the OFDM scheme.

A horizontal axis of the main radio module 1011 may represent a time tm. An arrow displayed at the lower end of the horizontal axis of the main radio module 1011 may be related to a power state (e.g., ON state or OFF state) of the main radio module 1011.

A vertical axis of the main radio module 1011 may be related to presence of a packet to be transmitted based on the main radio module 1011. A WUR module 1012 of FIG. 10 may correspond to the WUR module 512 of FIG. 5. Specifically, the WUR module 1012 may support only a reception operation for a packet modulated from the AP 1000 according to the OOK scheme.

A horizontal axis of the WUR module 1012 may represent a time tw. Further, an arrow displayed at the lower end of the horizontal axis of the WUR module 1012 may be related to a power state (e.g., ON state or OFF state) of the WUR module 1012.

In wake-up duration TW to T1 of FIG. 10, the WUR STA 1010 may be in a WUR mode.

For example, the WUR STA 1010 may control the main radio module 1011 to be in a doze state (i.e., OFF state). In addition, the WUR STA 1010 may control the WUR module 1012 to be in a turn-on state (i.e., ON state).

When a data packet for the WUR STA 1010 exists in the AP 1000, the AP 1000 may transmit a wake-up packet (WUP) to the WUR STA 1010 in a contention-based manner.

In this case, the WUR STA 1010 may receive the WUP based on the WUR module 1012 in a turn-on state (i.e., ON state). Herein, the WUP may be understood based on the description mentioned above with reference to FIG. 5 to FIG. 7.

In a first duration T1 to T2 of FIG. 10, a wake-up signal (e.g., 523 of FIG. 5) for waking up the main radio module 511 according to the WUP received in the WUR module 1012 may be transferred to the main radio module 511.

In the present specification, a time required when the main radio module 511 transitions from a doze state to an awake state according to the wake-up signal (e.g., 523 of FIG. 5) may be referred to as a turn-on delay (hereinafter, TOD).

Referring to FIG. 10, upon elapse of the TOD, the main radio module 511 may be in the awake state.

For example, upon elapse of the TOD, the WUR STA 1010 may control the main radio module 1010 to be in the awake state (e.g., ON state). For example, upon elapse of a wake-up duration TW to T1, the WUR STA 1010 may control the WUR module 1012 to be in the turn-on state (i.e., OFF state).

Subsequently, the WUR STA 1010 may transmit a power save poll (hereinafter, PS-poll) to the AP 1000 based on the main radio module 1011 in the awake state (i.e., ON state).

Herein, the PS-poll frame may be a frame for reporting that the WUR STA 1010 is able to receive a data packet for the WUR STA 1010 existing in the AP 1000 based on the main radio module 1011. In addition, the PS-poll frame may be a frame transmitted in a contention-based manner with respect to another wireless terminal (not shown).

Subsequently, the AP 1000 may transmit a first ACK frame (ACK #1) to the WUR STA 1010 in response to the PS-poll frame.

Subsequently, the AP 1000 may transmit the data packet for the WUR STA 1010 to the WUR STA 1010. In this case, the data packet (Data) for the WUR STA 1010 may be received based on the main radio module 1011 in the awake state (i.e., ON state).

Subsequently, the WUR STA 1010 may transmit a second ACK frame (ACK #2) to the AP 1000 to report that the data packet (data) for the WUR STA 1010 is successfully received.

Although not illustrated in FIG. 10, in second durations T2 and T3 of FIG. 10, a WUR STA 1010 may be again changed from a WLAN mode to a WUR mode for power saving.

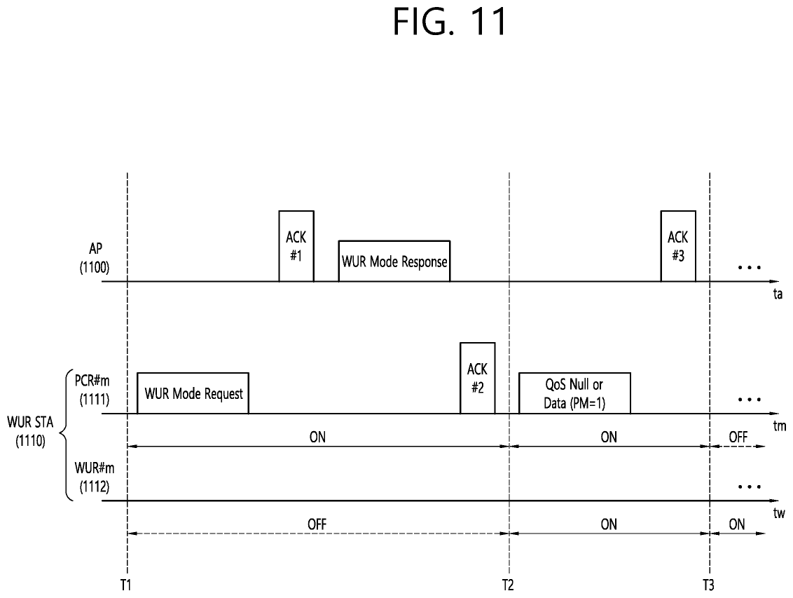

FIG. 11 is a diagram illustrating a signaling procedure for a WUR module according to the present embodiment.

Referring to FIGS. 10 and 11, an AP 1100 of FIG. 11 may correspond to the AP 1000 of FIG. 10, and a WUR STA 1110 of FIG. 11 may correspond to the WUR STA 1010 of FIG. 10. Further, a main radio module 1111 of FIG. 11 may correspond to a main radio module 1011 of FIG. 10, and a WUR module 1112 of FIG. 11 may correspond to a WUR module 1012 of FIG. 10.

For clear and concise understanding of FIG. 11, the WUR STA 1110 may be understood as a wireless terminal associated with the AP 1100 by performing an association procedure.

When the AP 1100 of FIG. 11 knows in advance an operation mode of the WUR STA 1110, the AP 1100 may efficiently transmit downlink data for the WUR STA 1110. That is, whenever the WUR STA 1110 wants to change an operation mode thereof, the WUR STA 1110 needs to notify the AP 1100 of this.

In first durations T1 and T2 of FIG. 11, the WUR STA 1110 may be in a WLAN mode. For example, the WUR STA 1110 may control the main radio module 1111 to be in an awake state (i.e., ON state). Further, the WUR STA 1110 may control the WUR module 1012 to be in a turn-off state (i.e., OFF state).

In this case, when the WUR STA 1110 wants to change an operation mode thereof from a WLAN mode to a WUR mode, the WUR STA 1110 may transmit a WUR mode request frame for a mode change to the AP 1100.

Thereafter, the WUR STA 1110 may receive a first ACK frame notifying successful reception of the WUR mode request frame from the AP 1100 based on the main radio module 1111.

Thereafter, the WUR STA 1110 may receive a WUR mode response frame based on the main radio module 1111 in response to the WUR mode request frame from the AP 1100. For example, the WUR mode response frame may include information approving a request for the mode change of the WUR STA 1110.

After transmitting a second ACK frame notifying successful reception of the WUR mode response frame, the WUR STA 1110 may operate in a WUR mode.

In second durations T2 and T3 of FIG. 11, the WUR STA 1110 may transmit, to the AP 1100, a QoS null frame or a data frame in which a power management (hereinafter, referred to as ‘PM’) field is set to ‘1’ based on the main radio module 1111.

Thereafter, the WUR STA 1110 may receive, from the AP 1100, a third ACK frame notifying successful reception of the QoS null frame or the data frame based on the main radio module 1111.

When the third ACK frame is received, the WUR STA 1110 may control the main radio module 1111 to change from an awake state (i.e., ON state) to a doze state (i.e., OFF state).

After a third time point T3 of FIG. 11, the WUR STA 1110 may operate in a WUR-PS mode. For example, the WUR STA 1110 may control the main radio module 1111 to be in the doze state. Further, the WUR STA 1110 may control the WUR module 1112 to be in a turn-on state.

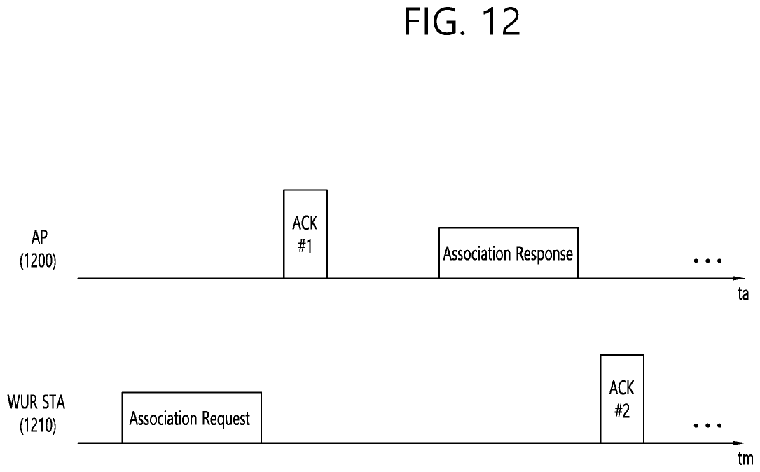

FIG. 12 is a diagram illustrating a method for communicating in a wireless LAN system according to the present embodiment.

An AP 1200 of FIG. 12 may correspond to the AP 1000 of FIG. 10, and a WUR STA 1210 of FIG. 12 may correspond to the WUR STA 1010 of FIG. 10. However, in FIG. 12, it is described on the premise that the WUR STA 1210 is a terminal before performing an association procedure with the AP 1200.

The WUR STA 1210 of FIG. 12 may transmit an association request frame requesting association with the AP 1200 to the AP 1200. In this case, it will be understood that the association request frame may be transmitted based on a main radio module (not illustrated) of the WUR STA 1210.

It will be understood that the association request frame of FIG. 12 corresponds to the association request frame 330 of FIG. 3. Here, the association request frame of FIG. 12 may further include operation information of the WUR STA 1210 including a WUR module.

For example, the operation information of the WUR STA 1210 may include time information required for the WUR STA 1210 to change a main radio module (not illustrated) from a doze state to an awake state. Here, the time information may be understood as a time corresponding to turn-on delay (TOD) of FIG. 10.

For example, the operation information of the WUR STA 1210 may include information on a transmission rate supported by the WUR module in order to receive a wakeup packet based on the WUR module.

For example, the operation information of the WUR STA 1210 may include information on a WUR channel supported by the WUR module in order to receive a wakeup packet based on the WUR module. Because the WUR channel may be different from the WLAN channel of the existing BSS, it may be necessary to notify in advance the AP of information on an operating class supported by the wireless terminal.

Additionally, when a length of a MAC body of the wake-up packet is greater than ‘0’, the operation information of the WUR STA 1210 may further include information on whether the WUR STA 1210 supports this.

Thereafter, the AP 1200 may transmit a first ACK frame for notifying successful reception of the association request frame to the WUR STA 1210. In this case, it will be understood that the first ACK frame may be received based on a main radio module (not illustrated) of the WUR STA 1210.

Thereafter, the AP 1200 may transmit an association response frame to the WUR STA 1210 in response to the association request frame. In this case, it will be understood that the association response frame may be received based on a main radio module (not illustrated) of the WUR STA 1210.

It will be understood that the association response frame of FIG. 12 corresponds to the association request frame 340 of FIG. 3.

That is, the AP 1200 may determine WUR related information for the WUR module based on the operation information of the WUR STA 1210 received through the association request frame. Here, the association response frame of FIG. 12 may include WUR related information determined by the AP 1200.

For example, time information required to change a main radio module (not illustrated) from a doze state to an awake state may be omitted or other information may be included as WUR related information. For example, other information may be information about a time to wait for retransmission of a wake-up packet.

For example, information on the transmission rate determined by the AP 1200 based on the information on the transmission rate supported by the WUR module in order to receive the wake-up packet may be included as WUR related information. When the requested transmission rate is not supported by the AP 1200, the WUR related information may include information rejecting the WUR STA 1210 request.

For example, information on the WUR channel determined by the AP 1200 based on the information on the WUR channel supported by the WUR module in order to receive the wakeup packet may be included as WUR related information. When the requested WUR channel is not supported by the AP 1200, the WUR related information may include information rejecting the WUR STA 1210 request.

Additionally, when a length of the MAC body of the wake-up packet is greater than ‘0’, the WUR related information of the AP 1200 may further include information on whether the AP 1200 supports this.

For example, in order to operate in the WUR mode, the STA needs to receive assignment of a WUR ID. However, when there is no assignable WUR ID, the corresponding STA cannot operate in the WUR mode until the WUR ID is assignable in a current BSS. The WUR related information may further include information on whether such an AP can support an STA to operate in the WUR mode.

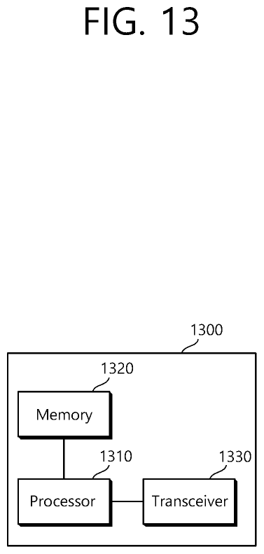

FIG. 13 is a block view illustrating a wireless device to which the exemplary embodiment of the present specification can be applied.

Referring to FIG. 13, as an STA that can implement the above-described exemplary embodiment, the wireless device may correspond to an AP or a non-AP station (STA). The wireless device may correspond to the above-described user or may correspond to a transmission device transmitting a signal to the user.

The wireless apparatus of FIG. 13, as shown, includes a processor 1310, a memory 1320 and a transceiver 1330. The illustrated processor 1310, memory 1320 and transceiver 1330 may be implemented as separate chips, respectively, or at least two blocks/functions may be implemented through a single chip.

The transceiver 1330 is a device including a transmitter and a receiver. If a specific operation is performed, only an operation of any one of the transmitter and the receiver may be performed or operations of both the transmitter and the receiver may be performed. The transceiver 1330 may include one or more antennas for transmitting and/or receiving a radio signal. Furthermore, the transceiver 1330 may include an amplifier for amplifying a received signal and/or a transmission signal and a bandpass filter for transmission on a specific frequency band.

The processor 1310 may implement the functions, processes and/or methods proposed in this specification. For example, the processor 1310 may perform the above-described operations according to the present embodiment. That is, processor 1310 may perform the operations disclosed in the embodiments of FIGS. 1 to 12.

The processor 1310 may include application-specific integrated circuits (ASIC), other chipsets, logic circuits, data processors and/or a converter for converting a baseband signal into a radio signal, and vice versa. The memory 1320 may include a read-only memory (ROM), a random access memory (RAM), a flash memory, a memory card, a storage medium and/or other storage devices.

In a detailed description of the present specification, specific embodiments have been described, but various modifications are possible without departing from the scope of the present specification. Therefore, the scope of the present specification should not be limited to the above-described embodiments, but should be determined not only by the claims below but also by the equivalents of the claims of the present specification.

1. A method in a wireless local area network (LAN) system,
transmitting, by a first wireless terminal, an association request frame to request association with a second wireless terminal to the second wireless terminal,
wherein the association request frame comprises operation information for a wake-up radio (WUR) module of the first wireless terminal,
wherein the operation information comprises time information required for changing a main radio module of the first wireless terminal from a doze state to an awake state; and
receiving, by the first wireless terminal, an association response frame from the second wireless terminal in response to the association request frame.

2. The method of claim 1, further comprising:
receiving, by the first wireless terminal, a wake-up packet modulated by an on-off keying (OOK) scheme from the second wireless terminal,
wherein the wake-up packet is received through the WUR module,
wherein the association request frame is transmitted through the main radio module,
wherein the operation information further comprises information on a transmission rate supported by the WUR module in order to receive the wake-up packet based on the WUR module.

3. The method of claim 2, wherein the association response frame comprises information rejecting the association, when the transmission rate is not supported by the second wireless terminal.

4. The method of claim 1, wherein the operation information further comprises information on a WUR channel supported by the WUR module in order to receive the wake-up packet based on the WUR module.

5. The method of claim 4, wherein the association response frame comprises information rejecting the association, when the WUR channel is not supported by the second wireless terminal.

6. A first wireless terminal in a wireless LAN system, the first wireless terminal comprising:
a transceiver that transmits or receives a wireless signal; and
a processor configured to control the transceiver, wherein the processor is configured to:
transmit an association request frame to request association with the second wireless terminal to the second wireless terminal,
wherein the association request frame comprises operation information for a wake-up radio (WUR) module of the first wireless terminal, and
wherein the operation information comprises time information required for changing a main radio module of the first wireless terminal from a doze state to an awake state, and
receive an association response frame from the second wireless terminal in response to the association request frame.

7. The wireless terminal of claim 6, wherein the processor is further configure to:
receive a wake-up packet modulated by an on-off keying (OOK) scheme from the second wireless terminal,
wherein the wake-up packet is received through the WUR module,
wherein the association request frame is transmitted through the main radio module,
wherein the operation information further comprises information on a transmission rate supported by the WUR module in order to receive the wake-up packet based on the WUR module.

8. The wireless terminal of claim 7, wherein the association response frame comprises information rejecting the association, when the transmission rate is not supported by the second wireless terminal.

9. The wireless terminal of claim 6, wherein the operation information further comprises information on a WUR channel supported by the WUR module in order to receive the wake-up packet based on the WUR module.

10. The wireless terminal of claim 9, wherein the association response frame comprises information rejecting the association, when the WUR channel is not supported by the second wireless terminal.
